(19) United States
(12) Patent Application Publication
(10) Pub. No.: US 2024/0095299 A1
(43) Pub. Date: Mar. 21, 2024

(54) CALCULATION ASSISTANCE SYSTEM, CALCULATION ASSISTANCE TERMINAL, CALCULATION TERMINAL, CALCULATION ASSISTANCE METHOD, AND STORAGE MEDIUM

(71) Applicant: CASIO COMPUTER CO., LTD., Tokyo (JP)

(72) Inventor: Masaaki YANAGISAWA, Tokyo (JP)

(73) Assignee: CASIO COMPUTER CO., LTD., Tokyo (JP)

(21) Appl. No.: 18/470,001

(22) Filed: Sep. 19, 2023

(30) Foreign Application Priority Data
Sep. 21, 2022 (JP) 2022-150523

(51) Int. Cl. G06F 17/11

(52) U.S. Cl. CPC G06F 17/11

(57) ABSTRACT

Provided is a calculation assistance system including a calculation terminal and a calculation assistance terminal, wherein the calculation terminal has an operation unit and a display unit, and with a communication connection established with the calculation assistance terminal, the calculation terminal performs the processes of acquiring calculation formula information, which is information on a calculation formula entered by the operation unit, performing a calculation on the basis of the calculation formula information, displaying a result of the calculation on the display unit, and transmitting the acquired calculation formula information to the calculation assistance terminal, and wherein the calculation assistance terminal performs the processes of determining whether the calculation being performed by the calculation terminal is to be assisted on the basis of the calculation formula information transmitted from the calculation terminal, and in the case of determining that the calculation is to be assisted, outputting calculation assistance information, which is information related to the assistance of calculation being performed by the calculation terminal.

### BACKGROUND

### 1. Field

This disclosure relates to a calculation assistance system, a calculation assistance terminal, a calculation terminal, a calculation assistance method, and a storage medium.

### 2. Related Art

Calculation terminals such as a general calculator and a scientific calculator are allowed to be used by a user who is familiar with their usage to easily perform calculations.

On the other hand, a personal computer (PC) and a smartphone are capable of performing more complex calculations and display graphs of calculation results by executing application programs for calculation or by using calculation services on the Internet (Web).

To supplement the functions of a calculator, there is known a technique of allowing a user to use services on the Internet from his/her calculator by accessing a server device via a terminal device having a function of accessing the Internet (web) (for example, Japanese Unexamined Patent Application Publication No. 2016-062504).

### SUMMARY

According to this disclosure, there is provided a calculation assistance system including a calculation terminal and a calculation assistance terminal, wherein the calculation terminal has an operation unit and a display unit, and with the calculation terminal in a state where a communication connection is established with the calculation assistance terminal, the calculation terminal performs the processes of acquiring calculation formula information, which is information on a calculation formula entered by the operation unit, performing calculation on the basis of the calculation formula information, displaying a result of the calculation on the display unit, and transmitting the acquired calculation formula information to the calculation assistance terminal; and the calculation assistance terminal performs the processes of determining whether the calculation being performed by the calculation terminal is to be assisted on the basis of the calculation formula information transmitted from the calculation terminal, and in the case of determining that the calculation is to be assisted, outputting calculation assistance information, which is information related to the assistance of calculation being performed by the calculation terminal.

### BRIEF DESCRIPTION OF THE DRAWINGS

FIG. 1 is a diagram illustrating an overall configuration of a calculation assistance system 1 according to an embodiment of the present invention.

FIG. 2 is a block diagram illustrating a configuration of an electronic circuit of a scientific calculator (calculation terminal) 10F.

FIG. 3 is a block diagram illustrating a configuration of an electronic circuit of a smartphone (calculation assistance terminal) 20.

FIG. 4 is a block diagram illustrating a configuration of an electronic circuit of a calculation information server (server device) 30.

FIG. 5 is a diagram illustrating an example of a calculation form stored in a calculation form database 23d of the smartphone 20, which is a calculation form (scalene triangle) 23d1 for “scalene triangle” among calculation forms classified as a mathematical formula collection.

FIG. 6 is a diagram illustrating an example of a calculation form stored in the calculation form database 23d of the smartphone 20, which is a calculation form (linear regression) 23d2 for “linear regression” among calculation forms classified as a calculation application collection.

FIG. 7 is a diagram illustrating an example of a calculation form stored in the calculation form database 23d of the smartphone 20, which is a calculation form (basal metabolic rate) 23d3 for “basal metabolic rate” among calculation forms classified as a health calculation.

FIG. 8 is a flowchart illustrating a process (Part 1) according to a calculator control program (including a calculation assistance terminal cooperative application) 14a of the scientific calculator (calculation terminal) 10F.

FIG. 9 is a flowchart illustrating a process (Part 2) according to a calculator control program (including a calculation assistance terminal cooperative application) 14a of the scientific calculator (calculation terminal) 10F.

FIG. 10 is a flowchart illustrating a process (Part 1) according to a terminal control program (including a calculation terminal assistance application and a web browser) 23a of the smartphone (calculation assistance terminal) 20.

FIG. 11 is a flowchart illustrating a process (Part 2) according to a terminal control program (including a calculation terminal assistance application and a web browser) 23a of the smartphone (calculation assistance terminal) 20.

FIG. 12 is a flowchart illustrating a calculation form search process (T10) included in the process (Part 1) of the smartphone (calculation assistance terminal) 20.

FIG. 13 is a diagram illustrating a state in which a high-accuracy calculation screen Gp of a result of calculation on the smartphone 20 based on the calculation formula entered by the scientific calculator 10F is displayed on the smartphone 20 as calculation assistance information.

FIG. 14 is a diagram illustrating a state in which the calculation form (scalene triangle) 23d1, which is searched for on the smartphone 20 on the basis of the calculation formula entered by the scientific calculator 10F, is displayed as a calculation form screen (scalene triangle) G1.

FIG. 15 is a diagram illustrating a state in which the calculation form (linear regression) 23d2, which is searched for on the smartphone 20 on the basis of the calculation formula entered by the scientific calculator 10F, is displayed as a calculation form screen (linear regression) G2.

FIG. 16 is a diagram illustrating a state in which the calculation form (basal metabolic rate) 23d3, which is searched for on the smartphone 20 on the basis of the calculation formula entered by the scientific calculator 10F, is displayed as a calculation form screen (basal metabolic rate) G3.

FIG. 17 is a flowchart illustrating a calculation formula information transmission process for transmitting calculation formula information in response to a key operation on the scientific calculator 10F to the smartphone 20.

FIG. 18 is a flowchart illustrating a calculation formula information receiving process for receiving calculation formula information in response to a key operation on the scientific calculator 10F in the smartphone 20.

### DETAILED DESCRIPTION

Hereinafter, the embodiments of the present disclosure are described with reference to drawings.

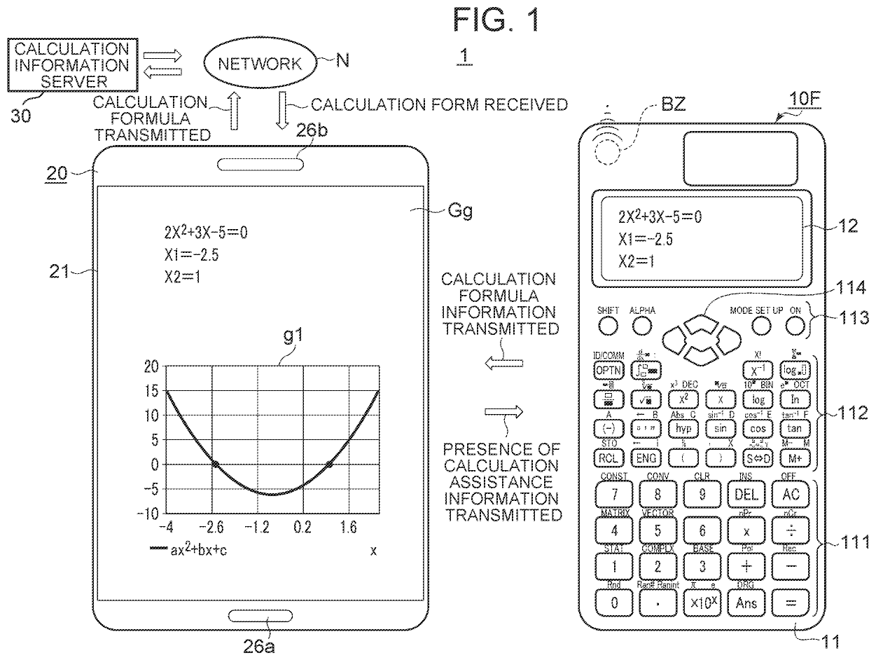

(Configuration of the embodiments) FIG. 1 is a diagram illustrating an overall configuration of a calculation assistance system 1 according to the present disclosure.

The calculation assistance system 1 is configured to include: a calculation terminal (in this case, a scientific calculator) 10F, which is operated by a user to perform calculations; a user's calculation assistance terminal (in this case, a smartphone) 20, which displays information to assist calculations (calculation assistance information) in response to calculations performed on the scientific calculator 10F; and a server device (in this case, a calculation information server) 30 provided on a communication network (in this case, the Internet) N by the manufacturer of the scientific calculator 10F, for example.

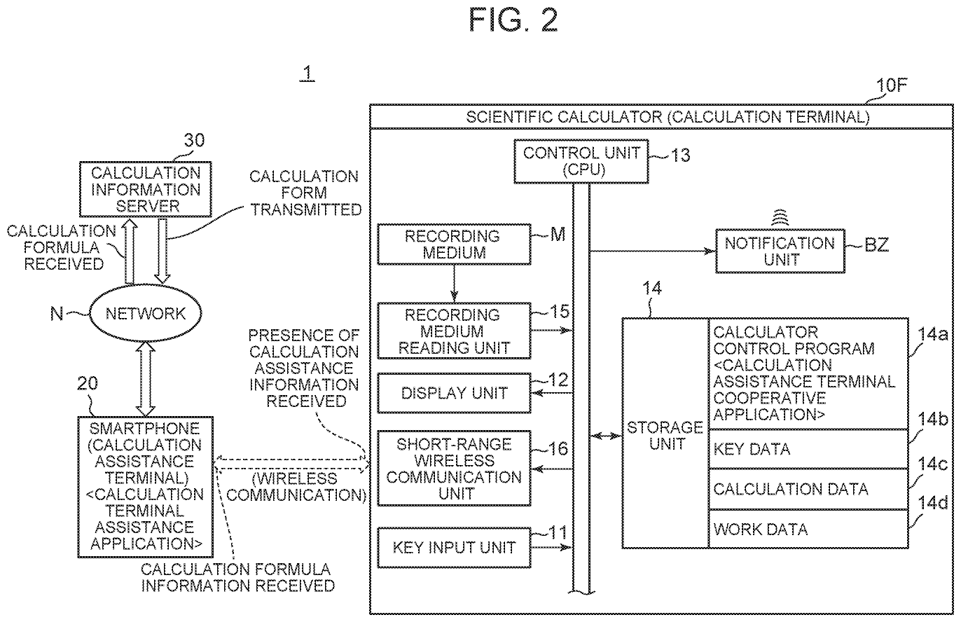

FIG. 2 is a block diagram illustrating a configuration of an electronic circuit of the scientific calculator (calculation terminal) 10F.

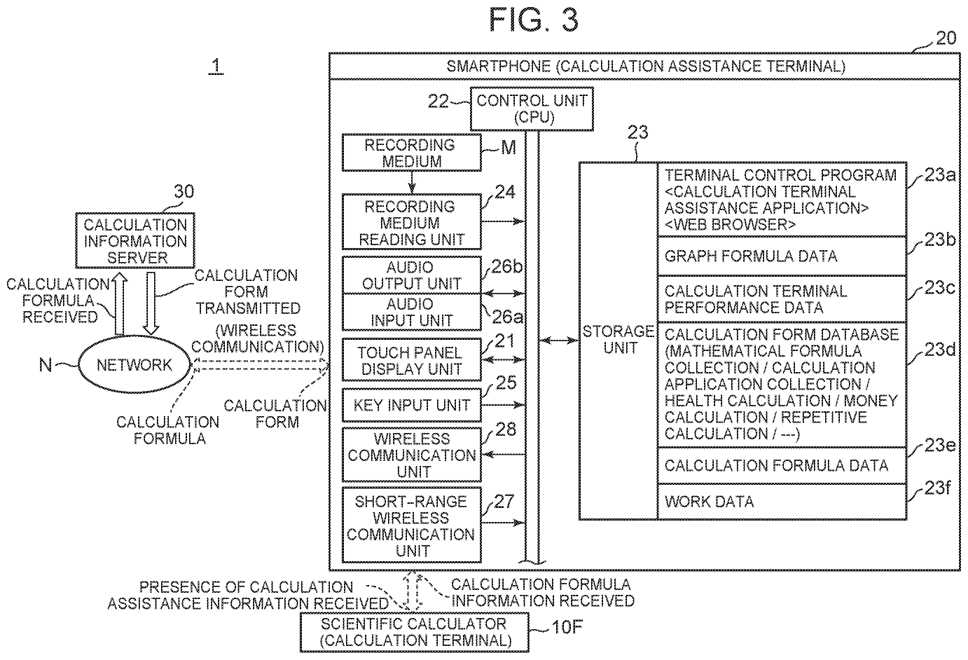

FIG. 3 is a block diagram illustrating a configuration of an electronic circuit of the smartphone (calculation assistance terminal) 20.

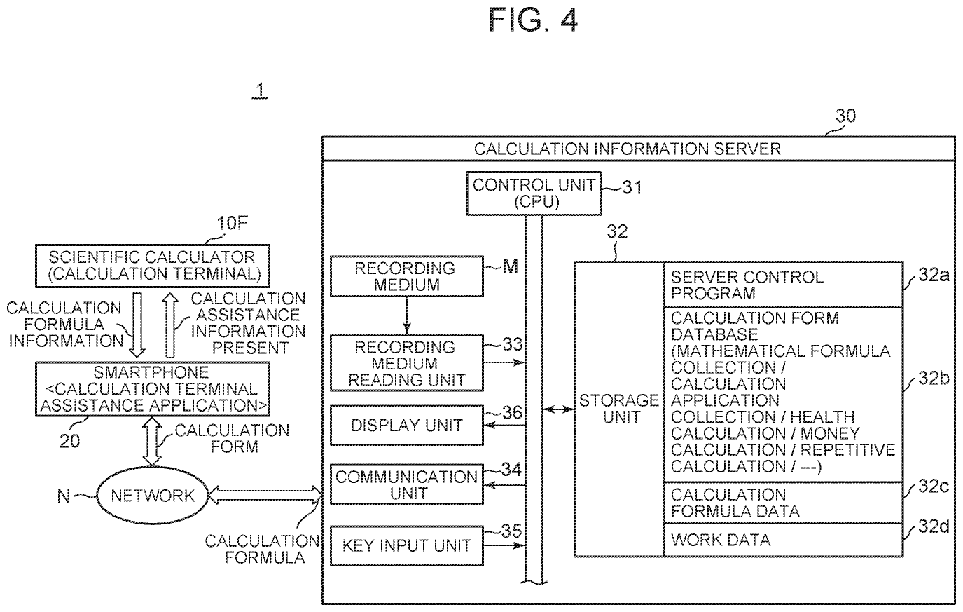

FIG. 4 is a block diagram illustrating a configuration of an electronic circuit of the calculation information server (server device) 30.

The scientific calculator (calculation terminal) 10F may be configured as an electronic device (calculation terminal) having: a control unit (central processing unit) 13, capable of performing calculations; a storage unit (memory) 14, which stores data; a short-range wireless communication unit 16, such as a Bluetooth (registered trademark), Bluetooth Low Energy (registered trademark), and near field communication (NFC), capable of communicating with the smartphone 20; a key input unit (keyboard: an operation unit) 11 capable of entering calculation formulas; and a display unit 12 (see FIG. 2).

The control unit 13 includes at least one processor.

The smartphone (calculation assistance terminal) 20 may be configured as an electronic device (calculation assistance terminal), such as a personal digital assistants (PDA), a tablet terminal, a notebook personal computer (PC), or a game machine, including: a control unit (central processing unit) 22; a storage unit (memory) 23 for storing data; a short-range wireless communication unit 27, such as Bluetooth (registered trademark), Bluetooth Low Energy (registered trademark), and near field communication (NFC) capable of communicating with the scientific calculator 10F; a (wireless) communication unit 28 such as Wi-Fi (registered trademark) capable of communicating with a web server (in this case, the calculation information server 30); and a (touch panel) display unit (display) 21 (see FIG. 3). The control unit 22 includes at least one processor.

As illustrated in FIG. 1, the scientific calculator 10F is small enough to be sufficiently grasped and operated by a user with one hand due to the need for its portability, and has the key input unit 11 and the display unit 12 on the front of its body.

The key input unit 11 includes a numerical value and operation symbol key group 111 for entering numerical values and calculation formulas and for instructing the execution of calculations, a function key group 112 for entering various functions and starting up memory functions, a mode setting key group 113 for displaying menu screens of various operation modes and for instructing the setting of operation modes, and a cursor key 114 for performing an operation of moving the cursor displayed on the display unit 12 and an operation of selecting data items.

The numerical value and operation symbol key group 111 includes [0] to [9] (numerical value) keys, [+], [−], [×], [+] (arithmetic symbol) keys, [Ans], [=] (execute) keys, [AC] (clear) key, and the like.

The function key group 112 includes a [x⁻¹] (−1 power; reciprocal) key, a [√□] (root; square root) key, a [□/□] (fraction) key, an [∫] (integral) key, a [log] (logarithm) key, a [sin] (sine) key, a [M+] (memory plus) key, an [OPTN] (option) key, a [RCL] (memory recall) key, and the like.

The mode setting key group 113 includes a [MODE] (mode) key, a [SHIFT] (shift) key, an [ALPHA] (alphabet) key, an [ON] (power on) key, and the like.

A key in the numerical value and operation symbol key group 111 or in the function key group 112 is able to function as a key described on the upper part of the key, instead of the key function described on the keycap, when the key is operated continuously after the [SHIFT] key is operated. For example, when the [AC] key is operated after the [SHIFT] key is operated (hereinafter, referred to as the [SHIFT]+[AC] key, or the like), the [OFF] (power off) key is applied. The [SHIFT]+[∫] key serves as a [d/dx] (differential) key, and the [SHIFT]+[tan] key serves as a [tan⁻¹] (arc tangent) key.

Mathematical symbols include operation symbols, function symbols, constant symbols, and the like that constitute a part of a calculation formula able to be entered by the key input unit 11.

The display unit 12 is made of a dot-matrix type (for example, 192×63 dots) liquid crystal display unit, which displays a calculation formula as in science and engineering books and textbooks (mathematical natural display).

As illustrated in FIG. 1, the smartphone 20 includes: a short-range wireless communication unit such as Bluetooth (not illustrated) capable of communicating with the scientific calculator 10F; a communication unit (not illustrated) capable of communicating with the calculation information server 30 via a communication network N; a touch panel display unit 21 that also functions as a touch input unit; an audio input unit 26a; and an audio output unit 26b.

The scientific calculator 10F has a calculation function (a1) that performs a calculation corresponding to the calculation formula entered in response to an operation of the key input unit 11 and displays the calculation result, has a calculation assistance terminal cooperative application (see 14a in FIG. 2) that works in conjunction with the smartphone (calculation assistance terminal) 20, and has a function (a2) of transmitting the key information (key data) of an entered key or the information of a calculation formula (calculation formula data) to the smartphone 20.

The smartphone 20 has a calculation terminal assistance application for displaying information for assisting calculations (calculation assistance information) in conjunction with the scientific calculator 10F and a web browser for displaying a web page provided by a web server (see 23a in FIG. 3), and has the following functions: a function (b1) of displaying a graph corresponding to the calculation formula entered by the scientific calculator 10F as calculation assistance information; a function (b2) of performing a high-accuracy calculation corresponding to the calculation formula entered by the scientific calculator 10F as a calculation assistance; and a function (b3) of searching for a calculation form (web page) corresponding to the calculation formula entered by the scientific calculator 10F in the calculation form database (see 23d in FIG. 3 and FIGS. 5 to 7) and displaying the search result as calculation assistance information; and a function (b4) of performing a calculation based on the displayed calculation form as a calculation assistance in cooperation with the scientific calculator 10F.

The calculation information server 30 has: a function (c1) of receiving calculation formula data transmitted from the smartphone 20; a function (c2) of searching for the calculation form (web page) corresponding to the received calculation formula in the calculation form database (32b in FIG. 4); a function (c3) of providing (transmitting) the calculation form (calculation form access point URL) searched for as calculation assistance information to the smartphone 20 and then getting the provided calculation form to work according to the web browser of the smartphone 20.

In the calculation assistance system 1 illustrated in FIG. 1, when a user is performing a calculation using the scientific calculator 10F, for example, while entering a calculation formula for a quadratic equation, a graph screen Gg of a graph g1 corresponding to the entered calculation formula (quadratic equation) is displayed on the smartphone 20 as calculation assistance information without the user being aware of it. In other words, even in the case where the user does not perform the operation of individually specifying the calculation formulas to be assisted in calculation, or even in the case where the user does not know whether the calculation assistance information is present for the entered calculation formula, or even in the case where the user does not know what type of calculation assistance information is present for the entered calculation formula, the user is able to easily obtain the calculation assistance information as long as the calculation assistance information is present for the entered calculation formula and the calculation assistance information relates to a function or performance that is not available on the scientific calculator 10F.

Because of the need to ensure portability, the scientific calculator 10F is configured with a small size for its housing and the screen size of the display unit 12, making it impossible to display graphs in a highly visible manner. Without being aware of whether the calculation formula entered by the scientific calculator 10F is a formula able to be displayed as a graph, the user is able to confirm the graph g1 corresponding to the entered calculation formula by automatically displaying the graph g1 on the smartphone 20 in the case where the entered calculation formula is a formula able to be displayed graphically.

When the calculation assistance information corresponding to the calculation formula entered by the scientific calculator 10F is acquired on the smartphone 20, the smartphone 20 notifies the scientific calculator 10F that the calculation assistance information has been acquired, and the scientific calculator 10F operates a notification unit BZ that emits electronic sounds to inform the user.

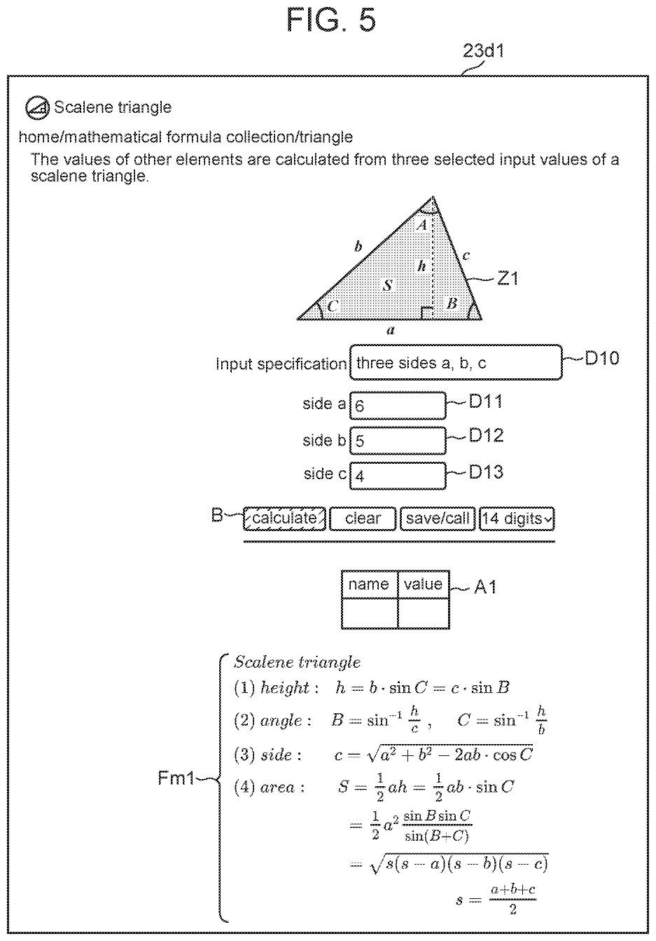

The calculation forms (web pages) stored in the calculation form database (23d in FIG. 3) of the smartphone 20 and the calculation form database (32b in FIG. 4) of the calculation information server 30 are described later (see FIGS. 5 to 7).

<Electronic Circuit of Scientific Calculator (Calculation Terminal) 10F>

As illustrated in FIG. 2, the electronic circuit of the scientific calculator (calculation terminal) 10F includes a control unit (CPU) 13, which is a computer, a storage unit 14, a recording medium reading unit 15, and a short-range wireless communication unit 16, in addition to the key input unit 11, the display unit 12, and the notification unit BZ.

The control unit 13 controls the operation of each part of the circuit according to the calculator control program (including the calculation assistance terminal cooperative application) 14a stored in the storage unit 14, and executes various processes in response to key input signals from the key input unit 11 and to received signals received from an external communication device (for example, the smartphone [calculation assistance terminal] 20) via the short-range wireless communication unit 16.

The calculator control program 14a includes a program for executing calculator functions, including at least the functions (a1) and (a2) described above.

The calculator control program 14a may be stored in the storage unit 14 in advance, or may be read and stored into the storage unit 14 from an external recording medium M such as a memory card via the recording medium reading unit 15. The calculator control program 14a is configured not to be able to be rewritten by the user by operating the key input unit 11.

Various data storage areas, such as a key data storage area 14b, a calculation data storage area 14c, and a work data storage area 14d, are further reserved in the storage unit 14.

The key data storage area 14b stores data of keys entered in response to the operation of the key input unit 11 or data of a calculation formula obtained by analyzing the data of an entered key each time, for example, the [Ans] [=] (execute) key is operated.

In the calculation data storage area 14c, data of the calculation result calculated based on data of the entered calculation formula and the like is stored.

In the work data storage area 14d, various types of data generated or acquired in response to the control of the operations of respective parts by the control unit 13 are temporarily stored as necessary.

The short-range wireless communication unit 16 has a function of performing wireless communication with an external communication device (for example, the smartphone 20) over a short distance, such as Bluetooth or near field communication (NFC).

In the scientific calculator (calculation terminal) 10F configured in this way, the control unit 13 controls the operations of respective parts of the circuit according to the instructions described in the calculator control program 14a, and the software and hardware work together to implement the calculator functions as described in the operation description below.

<Electronic Circuit of Smartphone (Calculation Assistance Terminal) 20>

As illustrated in FIG. 3, the electronic circuit of the smartphone (calculation assistance terminal) 20 includes a control unit (CPU) 22, which is a computer, a storage unit 23, a recording medium reading unit 24, a key input unit 25, a short-range wireless communication unit 27, and a wireless communication unit 28, in addition to the touch panel display unit 21, the audio input unit 26a, and the audio output unit 26b.

The control unit 22 controls the operations of respective parts of the circuit according to the terminal control program (including a calculation terminal assistance application and a web browser) 23a stored in the storage unit 23 to perform various processes in response to input signals from the touch panel display unit 21, the key input unit 25, and the audio input unit 26a, to received signals from external electronic devices (for example, a scientific calculator [calculation terminal] 10F) received via the short-range wireless communication unit 27, and to received signals from web servers (for example, a calculation information server [server device] 30) on the communication network N received via the wireless communication unit 28.

The control unit (CPU) 22 of the smartphone (calculation assistance terminal) 20 has more superior functions and performance related to calculations than the control unit (CPU) 13 of the scientific calculator (calculation terminal) 10F, and therefore is able to perform more complex calculations at high speed and with high accuracy. In addition, the display unit 21 of the smartphone (calculation assistance terminal) 20 has more superior functions and performance related to display than the display unit 12 of the scientific calculator (calculation terminal) 10F, and therefore is able to display more information related to calculations in a more visible manner since the display unit 12 has a higher resolution and a larger screen size and is able to display a much larger number of colors and digits. Functional performance information, which is information on functions and performance related to calculations and display of the smartphone (calculation assistance terminal) 20, is assumed to be stored in the storage unit 23 in advance.

The terminal control program 23a includes a program for performing the calculation terminal assistance functions including at least the aforementioned functions (b1), (b2), (b3), and (b4).

The terminal control program 23a may be stored in the storage unit 23 in advance, or may be read and stored in the storage unit 23 from an external recording medium M such as a memory card via the recording medium reading unit 24, or may be downloaded from a web server (in this case, a program server) on the communication network N via the wireless communication unit 28 and stored in the storage unit 23. The terminal control program 23a is configured not to be able to be rewritten by a user by operating the touch panel display unit 21 or the key input unit 25.

In the storage unit 23, there are further reserved various data storage areas, including a graph formula data storage area 23b, a calculation terminal performance data storage area 23c, a calculation form database 23d, a calculation formula data storage area 23e, and a work data storage area 23f.

The graph formula data storage area 23b stores graph formulas (formulas in the basic form in which variables are symbolized) each having the composition of a formula able to be displayed as a graph (for example, an equation, an inequality, a logarithmic and exponential function formula, or the like).

In the case of receiving a calculation formula entered by the scientific calculator 10F, the above graph formula is used to determine whether the composition of the formula matches (is similar to) the composition of one or more received calculation formulas and to determine whether the entered calculation formula is able to be displayed graphically.

The calculation terminal performance data storage area 23c stores functional performance information, which is information on the functions and performance of the calculation and display of the scientific calculator 10F, in association with the identification information (ID) of a plurality of types of calculation terminals (in this case, the scientific calculators 10F). For example, the calculation terminal performance data storage area 23c stores information such as the types (complexity) of calculation formulas able to be calculated, calculation speed, the number of digits able to be calculated, the displayable size, color, and the number of digits able to be displayed.

The functional performance information of the plurality of types of scientific calculators 10F is compared with the functional performance information of the smartphone (calculation assistance terminal) 20 when a calculation formula entered by the scientific calculator 10F is received, and is used to determine whether the smartphone 20 is superior to the scientific calculator 10F in calculation or display when performing calculation or display related to the received calculation formula. For example, the functional performance information of the plurality of types of scientific calculators 10F is used when determining whether the smartphone 20 is able to perform a calculation more quickly than the scientific calculator 10F, while the calculation formula is so complex that the scientific calculator 10F is not able to calculate the calculation formula or it takes time for the scientific calculator 10F to calculate the calculation formula though the scientific calculator 10F is able to calculate the calculation formula, or when determining whether the smartphone 20 is able to display more calculation result (the number of digits or the like) and is able to display the calculation result in an easy-to-view manner on a graph display or the like, while the scientific calculator 10F is not able to display all the information on the calculation result or, even if the scientific calculator 10F were able to display all the information, the display would not be easy to view, due to a great amount of information (the number of digits or the like) in the calculation result of the calculation formula.

In the calculation form database 23d, data of various calculation forms (web pages) downloaded in advance from the calculation information server 30 is stored, classified into, for example, the following categories: a mathematical formula collection; a calculation application collection; a health calculation; a money calculation; and a repetitive calculation, or the like.

The calculation form is a web page for calculation that differs for each type of calculation form, and the web page is generated by a program. The calculation form has an input field and an output field laid out, and has the function of performing a specific calculation according to the type of calculation form on the basis of the data entered in the input field and outputting the calculation result in the output field.

FIG. 5 is an example of a calculation form stored in the calculation form database 23d of the smartphone 20, and illustrates a calculation form (scalene triangle) 23d1 related to “scalene triangle” among the calculation forms classified as the mathematical formula collection.

The calculation form (scalene triangle) 23d1 includes, for example, a model diagram (scalene triangle) Z1 of an scalene triangle, an input specification field D10 for selectively specifying an input of calculation elements (a side, an angle, a height, and an area) indicated by the sign of the model diagram Z1, numerical input fields D11, D12, and D13 for entering values of the calculation elements specified by the input specification field D10 as variable values, a [Calculate] button B for instructing the execution of calculation, and a calculation result output field (scalene triangle) A1.

In addition, the calculation form (scalene triangle) 23d1 has a formula (scalene triangle) Fm1, which is a specific calculation formula corresponding to the type (scalene triangle) of the calculation form 23d1 for calculating the values of other calculation elements that have not been numerically entered on the basis of the numerical values entered according to the input specification field D10 and the numerical input fields D11, D12, and D13.

The plurality of calculation formulas expressed in Fm1 are the plurality of calculation formulas for identifying the calculation forms related to “scalene triangle,” and are used in the calculation form search process described later to determine whether the composition of the formula matches (is similar to) the composition of one or more received calculation formulas.

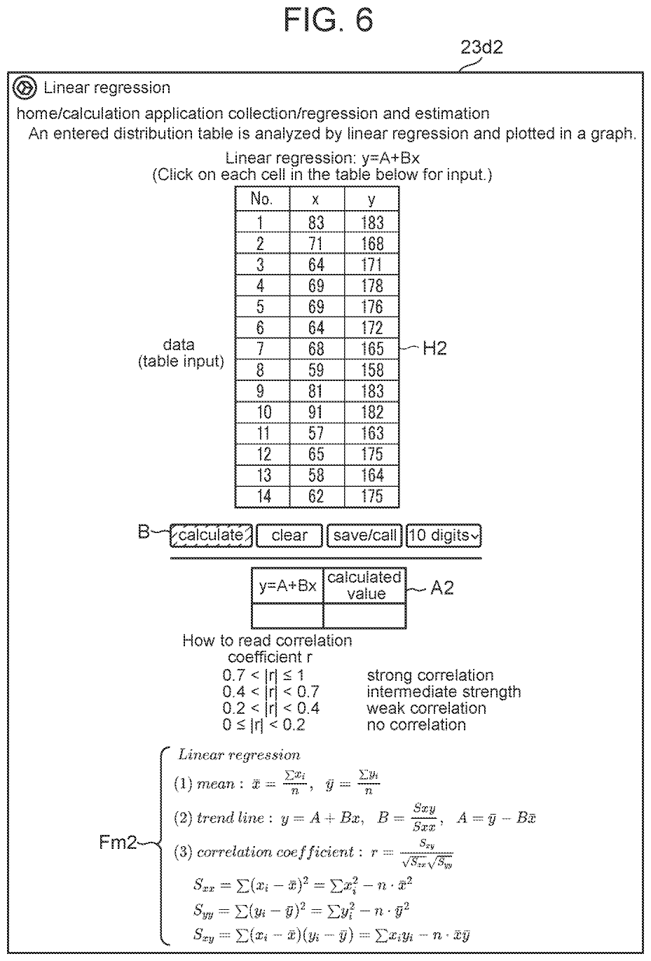

FIG. 6 is an example of a calculation form stored in the calculation form database 23d of the smartphone 20, and illustrates a calculation form (linear regression) 23d2 related to “linear regression” among the calculation forms classified as the calculation application collection.

The calculation form (linear regression) 23d2 includes, for example, a distribution table H2 for entering the values of calculation elements to be analyzed for linear regression (y=A+Bx) as variable values, the [Calculate] button B for instructing the execution of a calculation, and a calculation result output field (linear regression) A2.

In addition, the calculation form (linear regression) 23d2 has a formula (linear regression) Fm2, which is a specific calculation formula corresponding to the type (linear regression) of the calculation form 23d2 for calculating the estimated value of linear regression on the basis of the numerical values to be analyzed entered according to the distribution table H2.

The plurality of calculation formulas expressed in Fm2 are the plurality of calculation formulas for identifying the calculation forms related to “linear regression,” and are used in the calculation form search process described later to determine whether the composition of the formula matches (is similar to) the composition of one or more received calculation formulas.

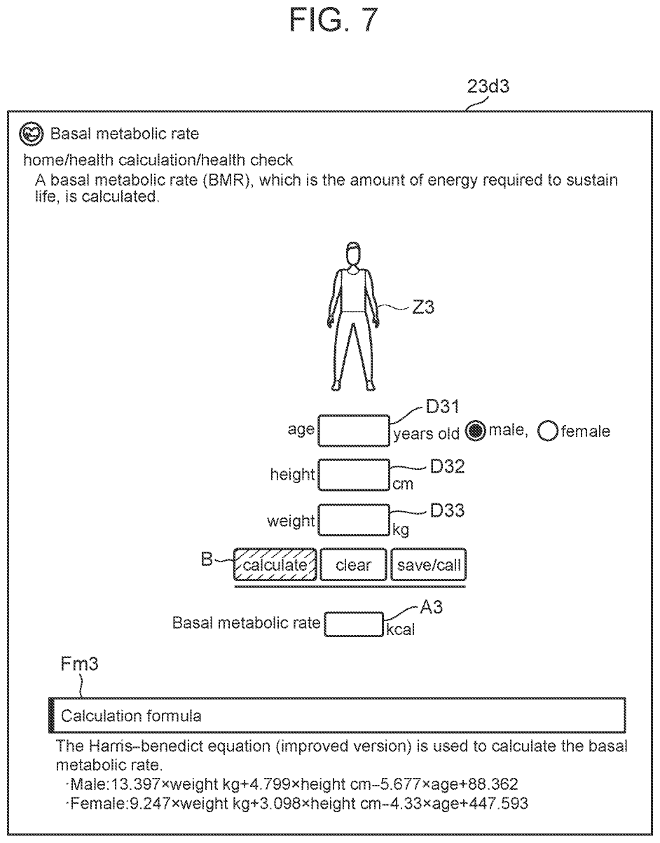

FIG. 7 is an example of a calculation form stored in the calculation form database 23d of the smartphone 20, and illustrates a calculation form (basal metabolic rate) 23d3 related to “basal metabolic rate” among the calculation forms classified as the health calculation.

The calculation form (basal metabolic rate) 23d3 includes, for example, a human model diagram Z3, numerical input fields D31, D32, and D33 for entering the values of calculation elements (an age, a height, and a weight) as variable values, the [Calculate] button B for instructing the execution of the calculation, and a calculation result output field (basal metabolic rate) A3.

Then, the calculation form (basal metabolic rate) 23d3 has a formula (basal metabolic rate) Fm3, which is a specific calculation formula corresponding to the type (basal metabolic rate) of the calculation form 23d3 for calculating the basal metabolic rate on the basis of the numerical values entered according to the numerical input fields D31, D32, and D33.

The plurality of calculation formulas expressed in Fm3 are the plurality of calculation formulas for identifying the calculation form related to “basal metabolic rate,” and are used in the calculation form search process described later to determine whether the composition of the formula matches (is similar to) to the composition of one or more received calculation formulas. Each of the formulas (specific calculation formulas) for obtaining the values of various calculation elements is made of a combination of variable symbols and mathematical symbols (arithmetic symbols, function symbols, constant symbols, and the like), though there are also formulas in which constants are directly combined as numerical values, for example, like the formula (basal metabolic rate) Fm3 illustrated in FIG. 7.

In the calculation form database 23d, the calculation forms classified as the repetitive calculation may include a calculation form (integral) convenient for integration based on the same function using, for example, a calculation formula including an integral as the formula (specific calculation formula) or a calculation form (spreadsheet) with a table of calculation elements that repeatedly use the same function, for example, as a formula (specific calculation formula) or the like.

Thus, each of the various calculation forms 23dn stored in the calculation form database 23d contains an input field Dn and an output field An for calculation elements according to the type n of the calculation form 23dn, and also has a formula (specific calculation formula) Fmn according to the type n of the calculation form 23dn.

The number of types n of the calculation form 23dn that is downloaded in advance from the calculation information server 30 and stored in the calculation form database 23d of the smartphone 20 is a certain amount less than the number of types m of a calculation form 32bm that the calculation information server 30 stores in its calculation form database 32b (see FIG. 4), for example, for each classification, because the storage capacity of the smartphone 20 is less than the storage capacity of the calculation information server 30, for example.

The calculation formula data storage area 23e stores the data of one or more calculation formulas received from the scientific calculator 10F in a communication connection with the scientific calculator 10F.

In the work data storage area 23f, various types of data generated or acquired in response to the control of the operations of respective parts by the control unit 22 are temporarily stored as necessary.

The short-range wireless communication unit 27 has a function of performing wireless communication with an external electronic device (for example, the scientific calculator 10F) over a short distance, such as Bluetooth, near field communication (NFC), and the like.

The wireless communication unit 28 has a function of performing wireless communication via a wireless router with a server device (for example, the calculation information server 30) on an external communication network N such as Wi-Fi.

In the smartphone (calculation assistance terminal) 20 configured as described above, the control unit 22 controls the operations of respective parts of the circuit in accordance with the instructions described in the terminal control program 23a, and software and hardware work together to achieve the calculation terminal assistance functions as described in the operation description below.

<Electronic Circuit of Calculation Information Server (Server Device) 30>

As illustrated in FIG. 4, the electronic circuit of the calculation information server 30 includes a control unit (CPU) 31, which is a computer, a storage unit 32, a recording medium reading unit 33, a communication unit 34, an input unit 35, and a display unit 36.

The control unit 31 controls the operations of respective parts of the circuit in accordance with a server control program 32a stored in the storage unit 32 and in response to input signals according to user operations from the input unit 35 or signals received by the communication unit 34 from a communication terminal (in this case, the smartphone 20) on the communication network N. The server control program 32a may be stored in the storage unit 32 in advance, or may be read and stored in the storage unit 32 from an external recording medium M such as a CD-ROM via the recording medium reading unit 33, or may be downloaded from another web server (in this case, a program server) on the communication network N via the communication unit 34 and stored in the storage unit 32.

The server control program 32a includes a program for performing the function of providing calculation information, including at least the aforementioned functions (c1), (c2), and (c3).

In the storage unit 32, a calculation form database 32b, a calculation formula data storage area 32c, and a work data storage area 32d are further reserved.

In the calculation form database 32b, data of various calculation forms (web pages) are stored, classified into, for example, the following categories: the mathematical formula collection; the calculation application collection; the health calculation; the money calculation; and the repetitive calculation; or the like. Among the various calculation forms stored in the calculation form database 32b of the calculation information server 30, for example, a certain small number of calculation forms in each category are downloaded and stored in advance in the calculation form database 23d of the aforementioned smartphone (calculation assistance terminal) 20.

In the calculation formula data storage area 32c, data of one or more calculation formulas received from the smartphone 20 is stored. This calculation formula data is received via the smartphone 20 in order to search for a calculation form corresponding to the same calculation formula from the calculation form database 32b of the calculation information server 30, in the case where the calculation form corresponding to the calculation formula is not retrieved in the calculation form database 23d of the smartphone 20 in response to a calculation operation performed by the user by using the scientific calculator 10F.

In the work data storage area 32d, various types of data generated or acquired in response to the control of the operations of respective parts by the control unit 31 are temporarily stored as necessary.

In the calculation information server 30 configured as described above, the control unit 31 controls the operation of each part of the circuit in accordance with an instruction described in the server control program 32a, and the software and hardware work together to achieve the calculation information provision function as described in the operation description below.

### Operation of the Embodiment

Subsequently, the operation of the calculation assistance system 1 of the embodiment is described.

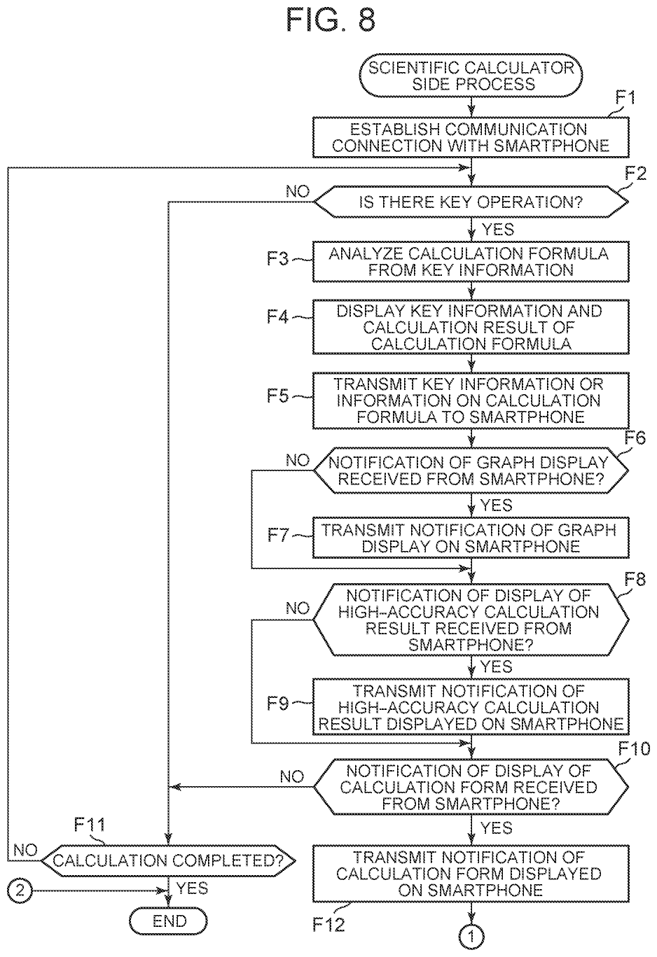

FIG. 8 is a flowchart illustrating a process (Part 1) according to a calculator control program (including a calculation assistance terminal cooperative application) 14a of the scientific calculator (calculation terminal) 10F.

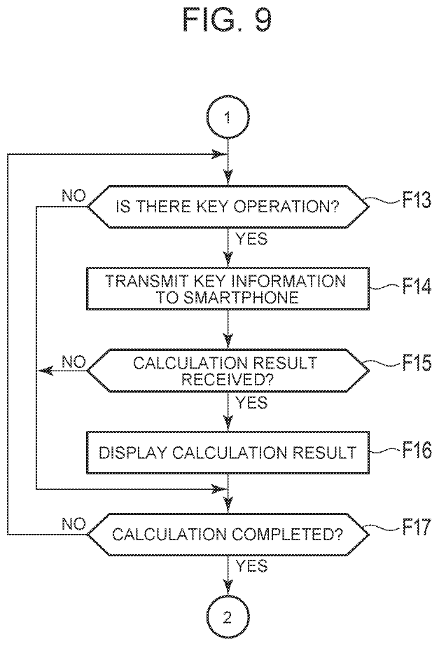

FIG. 9 is a flowchart illustrating a process (Part 2) according to a calculator control program (including a calculation assistance terminal cooperative application) 14a of the scientific calculator (calculation terminal) 10F.

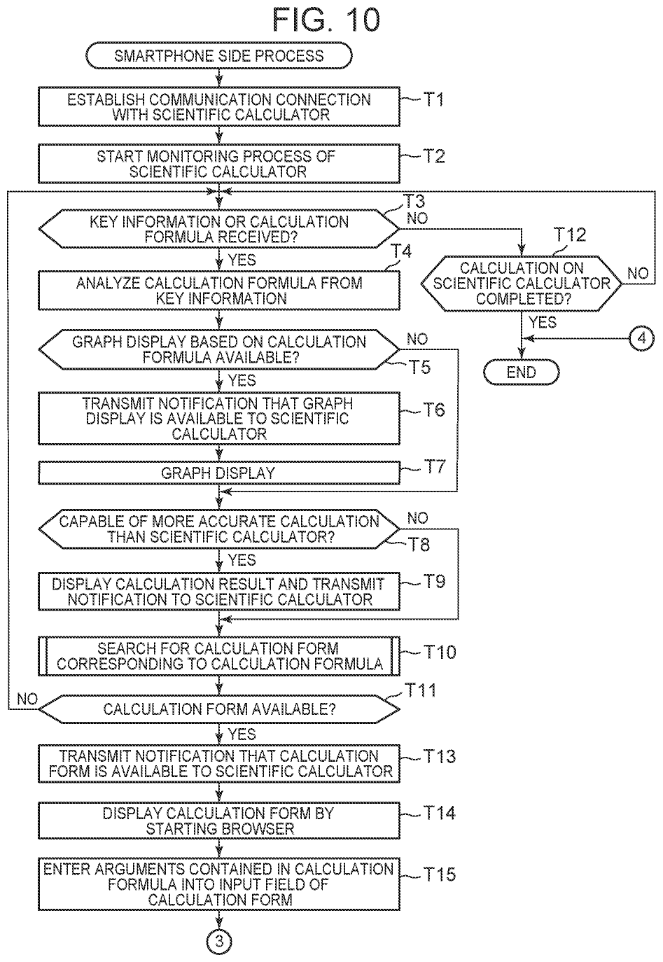

FIG. 10 is a flowchart illustrating a process (Part 1) according to a terminal control program (including a calculation terminal assistance application and a web browser) 23a of the smartphone (calculation assistance terminal) 20.

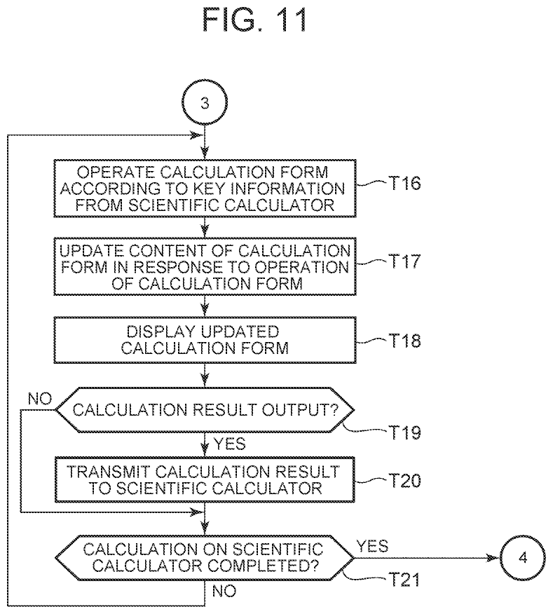

FIG. 11 is a flowchart illustrating a process (Part 2) according to a terminal control program (including a calculation terminal assistance application and a web browser) 23a of the smartphone (calculation assistance terminal) 20.

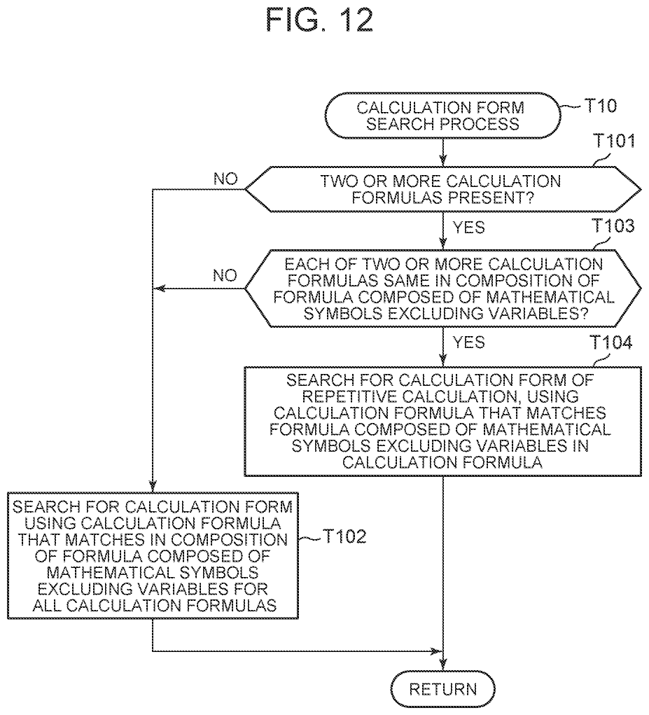

FIG. 12 is a flowchart illustrating a calculation form search process (T10) included in the process (Part 1) of the smartphone (calculation assistance terminal) 20.

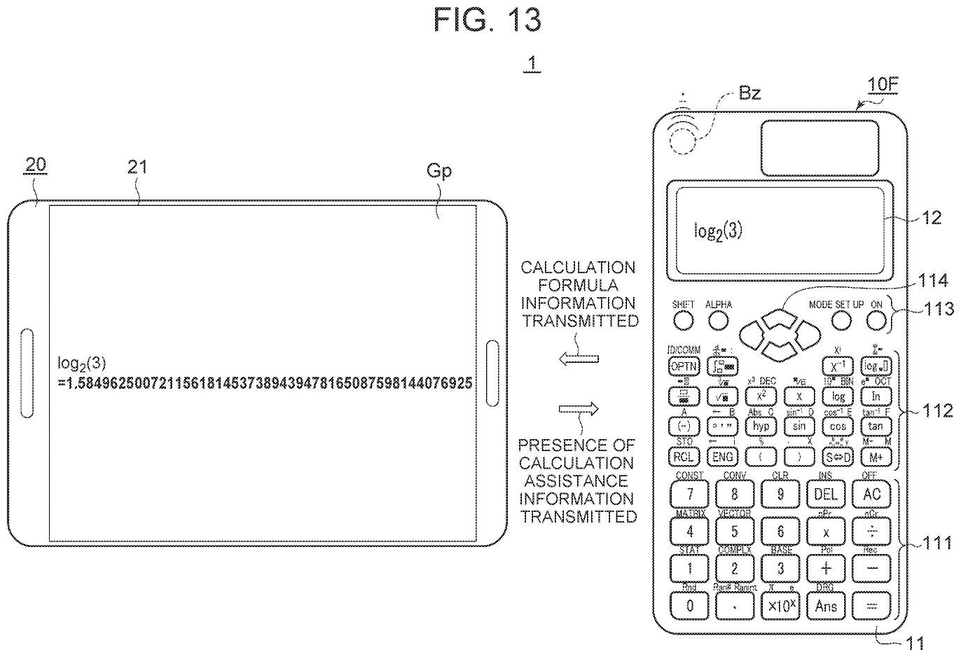

FIG. 13 is a diagram illustrating a state in which a high-accuracy calculation screen Gp of a result of calculation performed on the smartphone 20 based on the calculation formula entered by the scientific calculator 10F is displayed on the smartphone 20 as calculation assistance information.

In this specification, it is assumed that the smartphone 20 is present near the user (scientific calculator 10F) (within the communication range by the short-range wireless communication unit 16) in the case where the user performs a desired calculation using the scientific calculator 10F.

When the power is turned on by operating the [ON] key of the scientific calculator 10F, a mutual communication connection is established via the short-range wireless communication unit 16 of the scientific calculator 10F and the short-range wireless communication unit 27 of the smartphone 20 (step F1, step T1). Thereafter, in the case where there is performed a predetermined operation of instructing the start of the process related to the calculation assistance system 1, or in the case where there is set a mode for automatically starting a process related to the calculation assistance system 1, the control unit 13 starts executing the process according to the communication protocol between the scientific calculator 10F and the smartphone 20, which is predetermined in the calculation assistance system 1.

When a key operation is performed on the scientific calculator 10F by the user to enter a desired calculation formula (step F2 [YES]), the control unit 13 displays the entered key information on the display unit 12, analyzes the calculation formula from the entered key information (step F3), and displays the calculation result obtained by calculation based on the calculation formula on the display unit 12 (step F4).

The control unit 13 sequentially transmits to the smartphone 20 the calculation formula information, which is entered key information or information on an analyzed calculation formula and indicates a calculation formula detected by the control unit 13 by user's input, without detecting that the user has performed an operation of individually specifying the calculation formula to be assisted in calculation (step F5). Note that the calculation formula information includes information indicating four arithmetic operations and an operator such as a function and information representing the relationship with an argument (parameter) such as a numerical value to be calculated by the operator, the order of calculation, or the like, and the calculation formula information may also be information composed of a sequence of symbols and numerical values like a calculation formula written in a format easily understood by humans, as well as information composed of a sequence of symbols and numerical values in a format easily understood by the computer of a device. Furthermore, in the case where the rules for how a sequence of symbols or numerical values is to be interpreted as a calculation formula are predetermined among a plurality of devices constituting the calculation assistance system 1, the key information indicating the symbols or numerical values itself may be transmitted as calculation formula information.

The scientific calculator 10F may transmit the entered key information to the smartphone 20 for each input thereof, or may transmit the calculation formula analyzed each time the [=] (execute) key, for example, is operated from the entered key information, to the smartphone 20.

When a communication connection with the scientific calculator 10F is established in the smartphone 20 via the short-range wireless communication unit 27 (step F1, step T1) and in the case where the application program for performing the process related to the calculation assistance system 1 is started or a mode is set to automatically start the process related to the calculation assistance system 1, the control unit 22 starts a monitoring process for a received signal from the scientific calculator 10F that is received via the short-range wireless communication unit 27 as a process according to the communication protocol between the scientific calculator 10F and the smartphone 20 predetermined in the calculation assistance system 1 (step T2).

At this time, the control unit 22 identifies the functional performance information of the scientific calculator 10F stored in the calculation terminal performance data storage area 23c on the basis of the identification information (ID) of the scientific calculator 10F received in response to the communication connection with the scientific calculator 10F.

When key information or calculation formula information, which is calculation formula information transmitted from the scientific calculator 10F, is received in step F5 of FIG. 8 (step T3 [YES]), the control unit 22 analyzes the calculation formula from the received key information according to predetermined rules in the case where the received information is key information, and then stores data of the calculation formula indicated by the calculation formula information received from the scientific calculator 10F into the calculation formula data storage area 23e (step T4).

The control unit 22 determines whether a graph display corresponding to the received calculation formula is available on the basis of whether the composition of a formula composed of the mathematical symbols excluding variables, among the calculation formulas received from the scientific calculator 10F, matches (or is similar to) the composition of the graph formula stored in the graph formula data storage area 23b (step 15).

At this time, the control unit 22 compares the functional performance information of the scientific calculator 10F identified based on the identification information (ID) of the scientific calculator 10F with the functional performance information of the smartphone 20 stored in advance in the storage unit 23 of the smartphone 20, and also determines whether the calculation result of the calculation formula is able to be displayed more easily to view when using the graph display function of the smartphone 20 in the case of displaying the calculation result of the calculation formula, also taking into account the dimensions of variables included in the calculation formulas received from the scientific calculator 10F (whether the calculation result is suitable for graph display).

When it is determined that the graph display function of the smartphone 20 is capable of displaying a graph that is easier to view (step T5 [YES]), the control unit 22 transmits a notification that the graph display is available (notification of the presence of calculation assistance information) to the scientific calculator 10F (step T6).

As illustrated in FIG. 1, for example, the control unit 22 displays on the display unit 21 a graph screen Gg including a graph g1 corresponding to the calculation formula (in this case, a quadratic equation) received from the scientific calculator 10F, as calculation assistance information, along with the calculation formula (step T7).

In the scientific calculator 10F, when receiving the notification that the graph display transmitted from the smartphone 20 in step T16 of FIG. 10 is available (step F6 [YES]), the control unit 13 operates the notification unit BZ, for example, as illustrated in FIG. 1, to send a notification that the graph screen Gg including the graph g1 corresponding to the calculation formula entered by the user is displayed on the smartphone 20 (step F7).

Notification to the user that the graph display is available by the smartphone 20 may be made by audio output from the audio output unit 26b of the smartphone 20.

In the case where the calculation formula entered by the scientific calculator 10F is a formula able to be displayed graphically without being aware of whether the calculation formula is able to be displayed as a graph, the user is able to automatically display and confirm the graph screen Gg of the graph g1, which is easier to view than on the scientific calculator 10F, corresponding to the entered calculation formula, as the calculation assistance information on the smartphone 20.

Furthermore, the control unit 22 of the smartphone 20 compares the functional performance information of the scientific calculator 10F identified based on the identification information (ID) of the scientific calculator 10F with the functional performance information of the smartphone 20 stored in advance in the storage unit 23 of the smartphone 20 to determine whether the smartphone 20 is capable of more accurate calculation than the scientific calculator 10F (step T8).

At this time, the control unit 22 also takes into account the amount of information of the calculation result of the calculation formula received from the scientific calculator 10F, and determines whether the information (digits) of the calculation result is able to be displayed without missing information (dropped digits) when the calculation result of this calculation formula is displayed on the smartphone 20.

When it is determined (step T8 [YES]) that the smartphone 20 is capable of performing a higher-accuracy calculation without missing information (digits) (dropping digits) of the calculation result (with a greater amount of information) than the scientific calculator 10F (step T8 [YES]), the control unit 22 displays the calculation formula (in this case, a logarithmic function formula) received from the scientific calculator 10F as illustrated in FIG. 13, for example, and a high-accuracy calculation screen Gp that includes a calculation result of the calculation formula as the calculation assistance information on the display unit 21, and then transmits a notification that the high-accuracy calculation result is displayed (notification that the calculation assistance information is present) to the scientific calculator 10F (step T9).

In the scientific calculator 10F, when receiving the notification that the high-accuracy calculation result transmitted from the smartphone 20 in step T9 of FIG. 10 is displayed (step F8 [YES]), the control unit 13 operates the notification unit BZ as illustrated, for example, in FIG. 13, to send a notification that the high-accuracy calculation screen Gp including the calculation result of the calculation formula entered by the user is displayed on the smartphone 20 (step F9).

Also in this case, the notification to the user of the display of the high-accuracy calculation result by the smartphone 20 may be made by audio output from the audio output unit 26b of the smartphone 20.

Even in the case where the calculation formula entered by the scientific calculator 10F is not able to be calculated accurately with the calculation accuracy of the scientific calculator 10F due to, for example, overflowing digits, the user is able to, without being aware of it, automatically display and confirm the high-accuracy calculation screen Gp of the high-accuracy calculation result without dropped digits corresponding to the entered calculation formula on the smartphone 20.

In addition, the control unit 22 of the smartphone 20 searches the calculation form database 23d for the calculation form 23dn that uses a calculation formula (specific calculation formula) whose formula composition matches the composition of the calculation formula transmitted from the scientific calculator 10F in step F5 of FIG. 8 and received by the smartphone 20 in step T3 of FIG. 10 (step T10: calculation form search process).

When the calculation form 23dn that uses a calculation formula (a specific calculation formula) whose formula composition matches the composition of the calculation formula received from the scientific calculator 10F has been retrieved (present) (step T11 [YES]), the control unit 22 transmits a notification that the calculation form is available (notification that the calculation assistance information is present) to the scientific calculator 10F (step T13).

At this time, the control unit 22 compares the functional performance information of the scientific calculator 10F identified based on the identification information (ID) of the scientific calculator 10F with the functional performance information of the smartphone 20 stored in advance in the storage unit 23 of the smartphone 20, and also takes into account the type and complexity of the calculation formula received from the scientific calculator 10F to determine whether a faster and more accurate calculation is able to be performed when using the calculation function of the smartphone 20 (in this case, the calculation form 23d searched for in step T10) in calculating the calculation formula. Then, in the case where it is determined that a faster and more accurate calculation is able to be performed when using the calculation function of the smartphone 20, a notification that the calculation form is available (notification that the calculation assistance information is present) is transmitted to the scientific calculator 10F (step T13).

If the calculation form 23dn is not retrieved in step T10 (step T11 [NO]), the control unit 22 returns to standby for receiving the next calculation formula information from the scientific calculator 10F (step T3).

In the case where no calculation form that uses a calculation formula (formula) whose formula composition matches (is similar to) the composition of the calculation formula received from the scientific calculator 10F is retrieved from the calculation form database 23d in the smartphone (calculation assistance terminal) 20, a communication connection may be made with the calculation information server 30 to transfer data of the calculation formula received from the scientific calculator 10F to cause the calculation information server 30 to search the calculation form database 32b of the calculation information server 30 for the calculation form 32bm. In this case, the calculation form search process on the calculation information server 30 may be performed in the same manner as the calculation form search process (T10) on the smartphone 20 described below.

Here, the calculation form search process (T10) by the smartphone (calculation assistance terminal) 20 is described with reference to FIG. 12.

The control unit 22 determines whether there is a plurality of calculation formulas stored in the calculation formula data storage area 23e, in other words, calculation formulas received from the scientific calculator 10F (step T101).

In the case where there is no plurality of calculation formulas, in other words, there is only one calculation formula (step T101 [NO]), the control unit 22 searches the calculation form database 23d for a calculation form 23dn that uses a calculation formula (a specific formula) that matches in the composition of a formula composed of mathematical symbols excluding variables contained in a calculation formula for all calculation formulas (in this case, one) in the calculation formula data storage area 23e by comparing the calculation formulas (step T102).

In the case where a constant is directly combined as a numerical value, instead of a constant symbol (a mathematical symbol), in a calculation formula in the calculation formula data storage area 23e, for example, the control unit 22 distinguishes the numerical value that is a constant combined in a calculation formula in the calculation formula data storage area 23e and excludes the numerical value as a variable contained in the calculation formula, for example, on the basis of the database of constant values (constant value database) used for formulas (specific calculation formulas) for the various calculation forms, which have been stored in advance along with the various calculation forms in the calculation form database 23d.

On the other hand, in the case where there is a plurality of calculation formulas in the calculation formula data storage area 23e (step T101 [YES]), the control unit 22 determines whether each of the plurality of calculation formulas has the same composition of a formula composed of mathematical symbols excluding variables (step T103).

When it is determined that each of the plurality of calculation formulas in the calculation formula data storage area 23e has the same composition of a formula composed of mathematical symbols excluding variables (step T103 [YES]), the control unit 22 searches the calculation form database 23d for a calculation form 23dn classified as the repetitive calculation and using a calculation formula (a specific calculation formula) that matches a formula composed of mathematical symbols excluding variables in any of the plurality of calculation formulas, by comparison of the calculation formulas (step T104).

When there is a plurality of calculation formulas received from the scientific calculator 10F (step T101 [YES]) and when the composition of a formula composed of mathematical symbols excluding variables does not match the composition of each of the plurality of calculation formulas (step T103 [NO]), the control unit 22 searches the calculation form database 23d for calculation forms 23dn using calculation formulas (specific calculation formulas) that match in the composition of a formula composed of mathematical symbols excluding variables contained in the calculation formulas for all of the plurality of calculation formulas by comparing calculation formulas (step T102), instead of limiting the search to calculation forms classified as the repetitive calculation.

In the process of comparing and determining whether the composition of the formula composed of mathematical symbols excluding variables from the calculation formula received from the scientific calculator 10F matches the composition of the calculation formula (specific calculation formula) used by the calculation form, the terms in the formula may be before or after each other, as long as the mathematical symbols between terms match each other.

In the process of step T10 described above, regarding the determination of whether the plurality of calculation formulas received from the scientific calculator 10F matches the plurality of calculation formulas used by the calculation form, it may be determined that the match occurs when all of the plurality of calculation formulas used by the calculation form are contained in the plurality of calculation formulas received from the scientific calculator 10F, or it may be determined that the match occurs when a determined percentage of calculation formulas among the plurality of calculation formulas used by the calculation form are contained in the calculation formulas received from the scientific calculator 10F. It may also be determined that the match occurs when the degree of similarity is calculated by taking into account the weight of each calculation formula determined for each calculation form and the degree of similarity is equal to or greater than a predetermined level.

When it is determined that there is no matching calculation form in the process of step T11 described above, the calculation form with the highest degree of similarity among the plurality of calculation forms may be regarded as a matching calculation form and the process from step T13 may be continued.

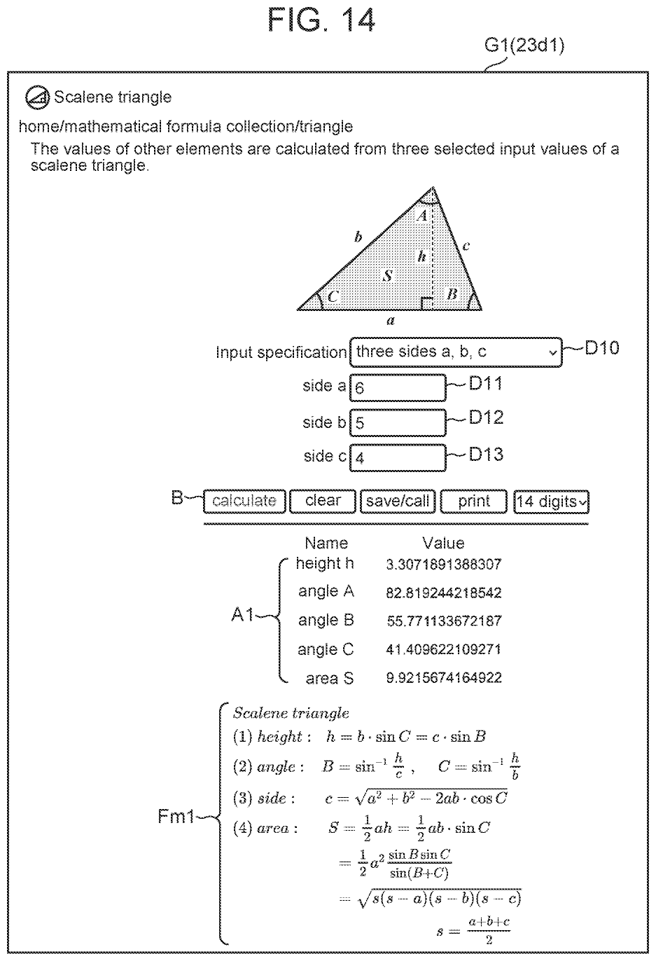

When a calculation form 23dn (or a calculation form 32bm of the calculation information server 30) capable of performing a calculation with higher speed and accuracy than the scientific calculator 10F that uses a calculation formula (specific calculation formula) whose formula composition matches the formula composition of the calculation formula received from the scientific calculator 10F has been retrieved (is present) (step T11 [YES]), the control unit 22 transmits a notification that the calculation form 23dn searched for is available (notification that the calculation assistance information is present) to the scientific calculator 10F (step T13). The control unit 22 starts a web browser and displays the calculation form (web page) 23dn (or 32bm) retrieved from the calculation form database 23d in step T10 as a calculation form screen (scalene triangle) G1 (23d1), for example, as illustrated in FIG. 14, on the touch panel display unit 21 (step T14).

The control unit 22 enters the arguments contained as variables in the calculation formula received from the scientific calculator 10F into the input field Dn of the calculation form (web page), and displays the screen data of the calculation form (web page) on the touch panel display unit 21 according to a request from the web browser (step T15).

In the scientific calculator 10F, upon receiving a notification that the calculation form transmitted from the smartphone 20 is available (notification that the calculation assistance information is present) in step T13 of FIG. 10 (step F10 [YES]), the control unit 13 operates the notification unit BZ to make a notification that the calculation formula entered by the user, in other words, the calculation form (web page) corresponding to the calculation that the user is performing, has been acquired and displayed on the smartphone 20 (step F12).

The user may be notified that the calculation form is available (displayed) on the smartphone 20 by audio output from the audio output unit 26b of the smartphone 20.

When the key input unit 11 of the scientific calculator 10F is operated (step F13 [YES]), the control unit 13 transmits the entered key information to the smartphone 20 for each that operation (step F14).

In the smartphone 20, the control unit 22 operates an operable target portion (the input field Dn, the button B, or the like) of the calculation form (web page) displayed on the touch panel display unit 21 according to the key information received from the scientific calculator 10F (step T16).

In the state where the calculation form is displayed on the smartphone 20, the key information received from the scientific calculator 10F, for example, plays a role of performing the operation of selecting, identifying, and displaying an operable target portion of the calculation form when the key is, for example, the cursor key 114. When the key is, for example, any of the [0] to [9] (numeric) keys, the key information plays a role of performing the operation of entering numerical values in the identified and displayed target portions (for example, the input field Dn). When the key is, for example, the [Ans] [=] (execute) key, the key information plays a role of performing the operation to cause the execution of the function of the identified and displayed target portion (for example, the button B).

When an operable target portion of the calculation form (Web page) displayed on the touch panel display 21 is operated on the smartphone 20, the control unit 22 updates the contents of the target portion of the calculation form in response to the operation (step T17). Specifically, for example, the control unit 22 enters a numerical value into the input field Dn of the calculation form, performs a calculation according to the formula (specific calculation formula), and outputs the calculation result to the calculation result output field An.

The control unit 22 displays the calculation form updated in response to the operation of the calculation form (web page) displayed in steps T16 and T17 (step T18). When the calculation result is output to the calculation result output field An of the calculation form (web page) (step T19 [YES]), the control unit 22 transmits data of the output calculation result to the scientific calculator 10F (step T20).

In the scientific calculator 10F, upon receiving the calculation result data transmitted from the smartphone 20 in step T20 of FIG. 11 (step F15 [YES]), the control unit 13 displays the received calculation result on the display unit 12 (step F16).

FIG. 14 is a diagram illustrating a state where the calculation form (scalene triangle) 23d1 searched for on the smartphone 20 on the basis of the calculation formula entered by the scientific calculator 10F has been displayed as the calculation form screen (scalene triangle) G1.

The calculation form screen (scalene triangle) G1 illustrated in FIG. 14 represents a state where the calculation results of other calculation elements (height h, angle A, angle B, angle C, and area S) calculated according to the formula (scalene triangle) Fm1 in the calculation form (scalene triangle) 23d1 in response to the operation of the [Calculate] button B, on the basis of the variable values of the calculation elements (side a, side b, and side c) entered in the numerical input fields D11, D12, and D13, are displayed in the calculation result output field (scalene triangle) A1.

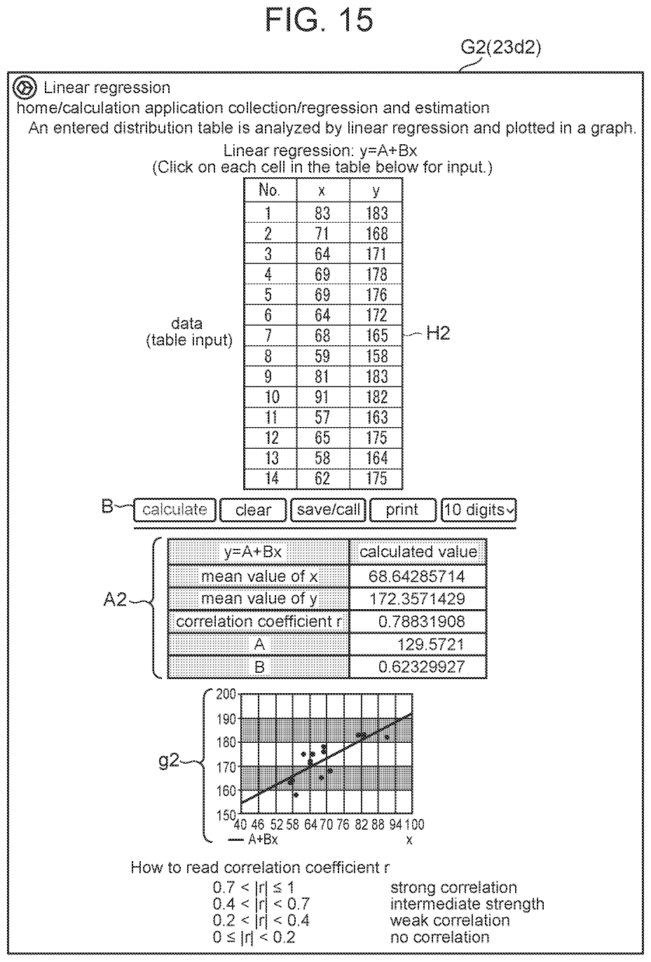

FIG. 15 is a diagram illustrating a state where the calculation form (linear regression) 23d2, which is searched for on the smartphone 20 based on the calculation formula entered by the scientific calculator 10F, is displayed as the calculation form screen (linear regression) G2.

The calculation form screen (linear regression) G2 illustrated in FIG. 15 represents a state where the calculation result as the analysis result calculated according to the formula (linear regression) Fm2 (see FIG. 6) in the calculation form (linear regression) 23d2 in response to the operation of the [Calculate] button B, on the basis of the variable values of the calculation elements, as analysis targets, entered in the distribution table H2, are displayed in the calculation result output field (linear regression) A2. The calculation form (linear regression) 23d2 also has a function of displaying the graph g2 of the regression line.

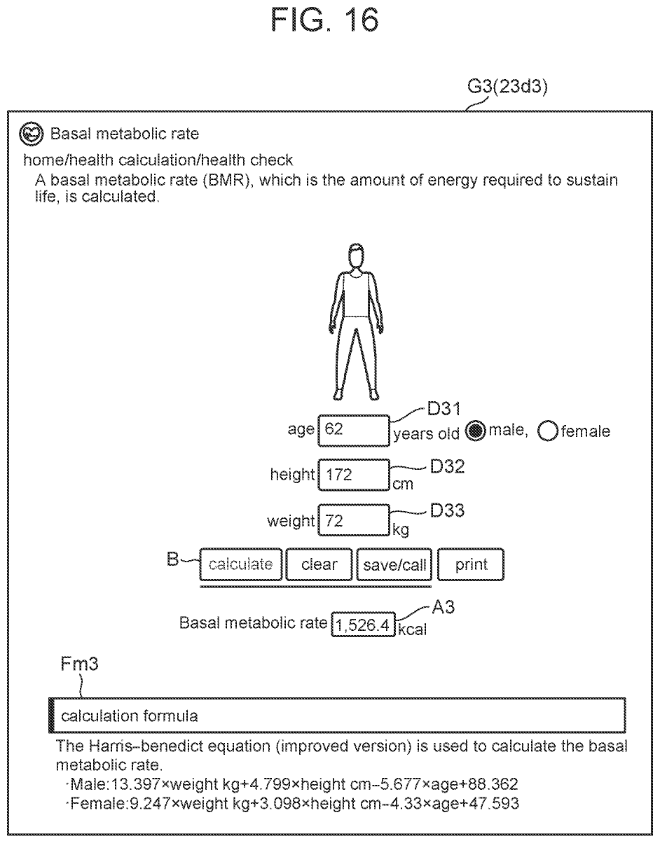

FIG. 16 is a diagram illustrating a state where the calculation form (basic metabolic rate) 23d3 searched for on the smartphone 20 on the basis of the calculation formula entered by the scientific calculator 10F is displayed as the calculation form screen (basic metabolic rate) G3.

The calculation form screen (basal metabolic rate) G3 illustrated in FIG. 16 represents a state where the calculation result calculated according to the formula (basal metabolic rate) Fm3 in the calculation form (basal metabolic rate) 23d3 in response to the operation of the [Calculate] button B, on the basis of the variable values of the calculation elements (age, height, and weight) entered in the numerical input fields D31, D32, and D33, are displayed in the calculation result output field (basal metabolic rate) A3.

As described above, the user is able to acquire, display, and use a calculation form that enables faster and more accurate calculations than the scientific calculator 10F corresponding to the type of calculation being performed using the scientific calculator 10F, for example, as calculation assistance information on the smartphone 20 without the user being aware of the calculation form during the calculation process. In addition, the calculation result in the calculation form is also able to be displayed on the scientific calculator 10F at hand for confirmation. The display of the calculation result on the scientific calculator 10F is limited according to the number of digits able to be displayed on the display unit 12 and to the screen size, but may be displayed over a plurality of lines or by scrolling the display range.

In the scientific calculator 10F, when calculation is completed by, for example, the [AC] (clear) key operation (step F11 [YES]) in a state where no key operation is performed (step F2 [NO]) or in a state where no notification that a calculation form is available is received from the smartphone 20 in step T13 of FIG. 10 (step F10 [NO]), or when calculation is completed (step F17 [YES]) in a state of using the calculation form 23dn displayed on the smartphone 20 in steps T16 to T20 of FIG. 11 (steps F13 to F16), the control unit 13 transmits a notification that the calculation is completed to the smartphone 20, and the series of processes is completed.

In the smartphone 20, when a notification that the calculation is completed is received from the scientific calculator 10F (step T12 [YES]) in a state where no key information or no calculation formula information is received from the scientific calculator 10F (step T3 [NO]), or when a notification that the calculation is completed is received from the scientific calculator 10F (step T21 [YES]) in a state where the calculation form 23dn is displayed according to the web browser (steps T16 to T20), the control unit 22 stops the communication connection with the scientific calculator 10F and the calculation information server 30, and the series of processes is completed.

In the smartphone 20, when none of the graph screen Gg, the high-accuracy calculation screen Gp, and the calculation form screen Gn is displayed without acquiring any of the calculation assistance information (graph g1, high-accuracy calculation result, and calculation form 23dn) corresponding to the calculation formula received from the scientific calculator 10F, the user is not aware of the scientific calculator 10F being operated by the user is linked to the smartphone 20.

<Calculation Formula Information Transmission Process of Scientific Calculator 10F>

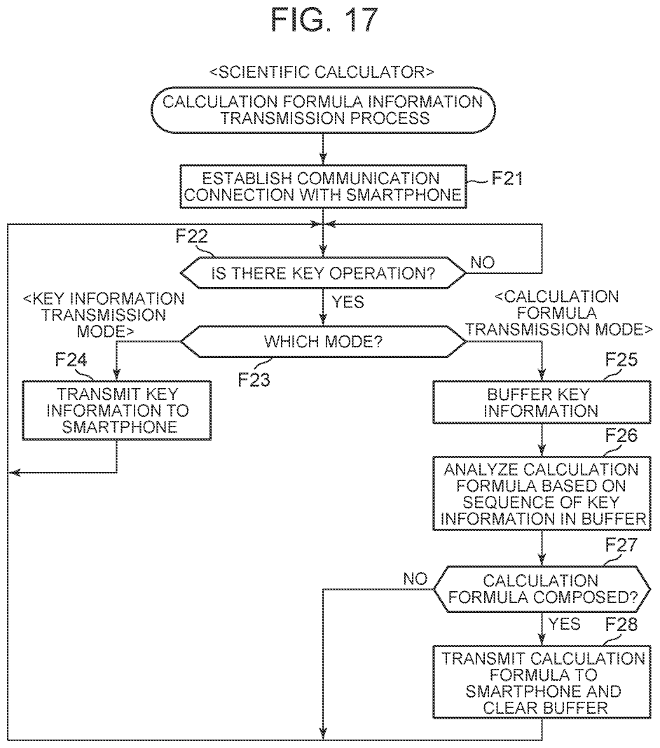

FIG. 17 is a flowchart illustrating a calculation formula information transmission process for transmitting calculation formula information in response to a key operation on the scientific calculator 10F to the smartphone 20.

It is assumed here that any of the two modes (“key information transmission mode” or “calculation formula transmission mode”) for transmitting key information to the smartphone 20 is able to be set according to the setting menu of the operation mode displayed on the display unit 12 in response to the operation of the [MODE] (mode) key on the scientific calculator 10F.

The control unit 13 of the scientific calculator 10F establishes a communication connection with the smartphone 20 via the short-range wireless communication unit 16 (step F21) and waits for the key operation to be accepted by the key input unit 11 (step F22).

When the key operation is accepted by the key input unit 11 (step F22 [YES]), the control unit 13 determines whether the set operation mode is the “key information transmission mode” or the “calculation formula transmission mode” (step F23).

In the case where the set operation mode is the “key information transmission mode” (step F23 <key information transmission mode>), the control unit 13 transmits key information (calculation formula information) corresponding to the operated key to the smartphone 20 (step F24).

On the other hand, in the case where the set operation mode is the “calculation formula transmission mode” (step F23 <calculation formula transmission mode>), the control unit 13 buffers the key information corresponding to the operated key into, for example, the work data storage area 14d (step F25), and analyzes the calculation formula on the basis of the sequence of the buffered key information (step F26).

The control unit 13 transmits the analyzed calculation formula (calculation formula information) to the smartphone 20 each time the [Ans] [=] (Execute) key is operated, for example, and clears the buffered key information (steps F27 and F28).

In the case where the “key information transmission mode” is set, the load on the control unit 13 is lighter than in the case where the “calculation formula transmission mode” is set, thereby enabling a reduction in power consumption.

<Calculation Formula Information Receiving Process of Smartphone 20>

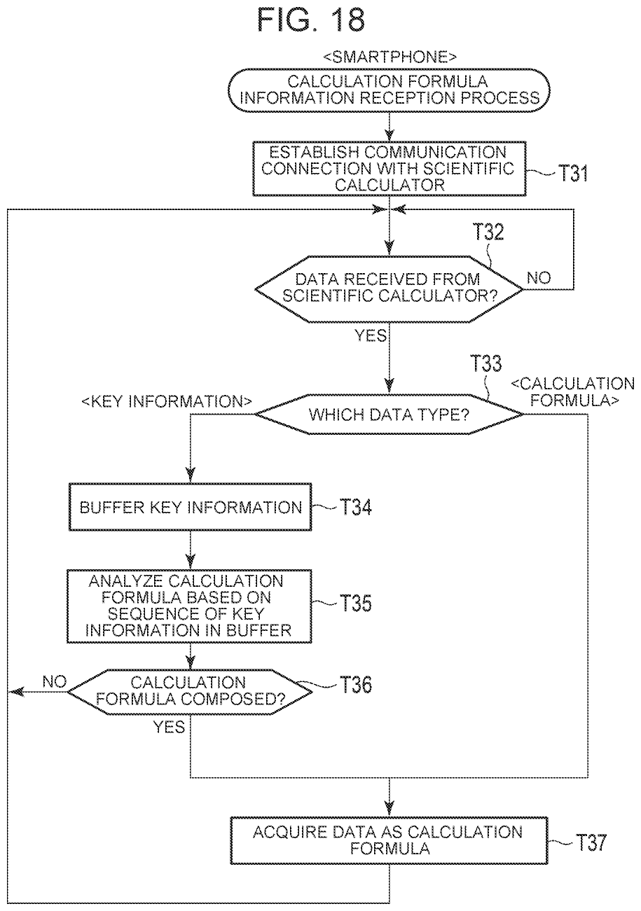

FIG. 18 is a flowchart illustrating a calculation formula information receiving process for receiving calculation formula information in response to a key operation on the scientific calculator 10F in the smartphone 20.

The control unit 22 of the smartphone 20 establishes a communication connection with the scientific calculator 10F via the short-range wireless communication unit 27 (step T31) and waits for data to be received from the scientific calculator 10F (step T32).

When data is received from the scientific calculator 10F (step T32 [YES]), the control unit 22 determines whether the type of data received is key information as calculation formula information or a calculation formula as calculation formula information (step T33), and in the case where it is key information (step T33 <key information>), the key information is buffered into, for example, the work data storage area 23f (step T34).

The control unit 22 analyzes the calculation formula on the basis of the sequence of the buffered key information (step T35), and each time key information corresponding to the [Ans] [=] (Execute) key is received, for example, the control unit 22 adds the analyzed calculation formula to the calculation formula data storage area 23e and stores the calculation formula (steps T36 and T37).

On the other hand, in the case where the type of data received is a calculation formula (step T33 <calculation formula>), the control unit 22 adds the received calculation formula to the calculation formula data storage area 23e to store the calculation formula (step T37).

Thus, even in the case where the operation mode associated with the key operation of the scientific calculator 10F is set to either the “key information transmission mode” or the “calculation formula transmission mode,” the smartphone 20 is able to acquire the calculation formula corresponding to the key operation of the scientific calculator 10F and to perform the process described above with reference to FIGS. 10 and 11.

### Summary of Embodiments

According to the calculation assistance system 1 of the embodiment, when a user enters a calculation formula by a key operation of the scientific calculator (calculation terminal) 10F and performs a calculation, the entered calculation formula is sequentially transmitted to the smartphone (calculation assistance terminal) 20. The smartphone 20 determine whether the graph display function of the smartphone 20 is able to be used to display graphs that are easier to view by determining whether the received calculation formula matches (is similar to) various graph formulas (formulas) able to be displayed as graphs in the formula composition and by comparing the functional performance information of the scientific calculator 10F with the functional performance information of the smartphone 20. In the case where the smartphone 20 is capable of displaying graphs that are easier to view, the smartphone 20 then displays the graph screen Gg of the graph g1 corresponding to the calculation formula as calculation assistance information.

Without being aware of whether the calculation formula entered by the scientific calculator 10F is a formula able to be displayed as a graph, the user is able to automatically display the graph g1 corresponding to the entered calculation formula on the smartphone (calculation assistance terminal) 20 for confirmation in the case where the calculation formula is a formula able to be displayed as a graph that is easier to view on the smartphone 20. Moreover, the smartphone (calculation assistance terminal) 20 determines whether the received calculation formula is able to be calculated with higher accuracy for display than the scientific calculator 10F without missing information (digits) of the calculation result (without dropped digits) (more amount of information than the scientific calculator 10F), on the basis of a comparison between the functional performance information of the scientific calculator 10F and the functional performance information of the smartphone 20. In the case where the calculation formula is able to be calculated with higher accuracy, the smartphone 20 performs the calculation of the calculation formula and displays the high-accuracy calculation screen Gp of the calculation result as calculation assistance information.

Even in the case where the calculation formula entered by the scientific calculator 10F is not able to be calculated accurately due to, for example, overflowing digits, with the calculation accuracy of the scientific calculator 10F, the user is, without being aware thereof, able to automatically display the high-accuracy calculation screen Gp of the high-accuracy calculation result without dropped digits corresponding to the entered calculation formula, as calculation assistance information, on the smartphone (calculation assistance terminal) 20 for confirmation.

In addition, the smartphone (calculation assistance terminal) 20 also searches for a calculation form using the formula that matches (is similar to) the received calculation formula in the formula composition on the basis of the calculation form database 23d, which stores various calculation forms (web pages) downloaded in advance from the calculation information server 30, and compares the functional performance information of the scientific calculator 10F with the functional performance information of the smartphone 20 to determine whether the retrieved calculation form 23d is able to be used to perform a higher-accuracy calculation at a higher speed than the scientific calculator 10F. In the case of determining that the calculation is able to be performed at a higher speed and with higher accuracy than on the scientific calculator 10F, the smartphone 20 displays the calculation form screen Gn of the retrieved calculation form 23dn as calculation assistance information according to the web browser. Thereafter, according to the key information from the scientific calculator 10F, the numerical value input field Dn and the [Calculate] button B of the calculation form 23dn being displayed are operated for updating, and the calculation result calculated according to the calculation form 23dn is displayed in the calculation result output field An. Then, the smartphone 20 transmits data of the calculation result output to the calculation result output field An to the scientific calculator 10F to display the data on the display unit 12.

The user is able to automatically acquire and display the calculation form corresponding to the type of calculation being performed using the scientific calculator 10F, as calculation assistance information, on the smartphone (calculation assistance terminal) 20 without the user being aware of the calculation form during the calculation process, for example, to use the calculation form.

This enables an increase in the convenience for the user to perform a calculation using the calculation terminal (scientific calculator 10F).

All of the methods of respective processes by the calculation assistance system 1 described in the above embodiments, in other words, the methods of the process of the scientific calculator (calculation terminal) 10F illustrated in the flowcharts of FIGS. 8 and 9, the process of the smartphone (calculation assistance terminal) 20 illustrated in the flowcharts of FIGS. 10, 11, and 12, a calculation formula information transmission process of the scientific calculator (calculation terminal) 10F illustrated in the flowchart of FIG. 17, a calculation formula information receiving process of the smartphone (calculation assistance terminal) 20 illustrated in the flowchart of FIG. 18, and the like are able to be distributed as programs allowed to be executed by a computer, being stored in a memory card (ROM card, RAM card, or the like), a magnetic disk (a floppy [registered trademark] disk, a hard disk, or the like), an optical disk (a CD-ROM, a DVD, or the like), a semiconductor memory, or other external recording device media. In addition, the control unit (CPU) of the electronic device reads the program recorded on the medium of the external recording device into the storage device, and the operation is controlled by the read program, thereby enabling the various functions described in the embodiments to be implemented and the same processes by the aforementioned methods to be performed.

Additionally, the data of the program for implementing each method is able to be transmitted over a communication network (N) in the form of a program code, and the data of the program is also able to be imported into an electronic device from a computer device (program server) connected to the communication network (N) and to be stored in a storage device to implement various functions described above.

The present invention is not limited to the above embodiments, but may be transformed in various ways in the implementation stage without departing from the gist of the invention. In addition, the respective embodiments may be implemented in combination as appropriate, in which case the combined effect is obtained. Furthermore, various inventions are included in the above embodiments, and various inventions may be extracted by combinations selected from the plurality of configuration requirements disclosed. For example, in the case where a problem can be solved and an effect can be obtained, for example, even if some configuration requirements are deleted from all the configuration requirements described in the embodiments, the configuration from which these configuration requirements are deleted may be extracted as an invention.

What is claimed is:

1. A calculation assistance system comprising a calculation terminal and a calculation assistance terminal, wherein:
the calculation terminal has an operation unit and a display unit;
with the calculation terminal in a state where a communication connection is established with the calculation assistance terminal,
the calculation terminal performs the processes of acquiring calculation formula information, which is information on a calculation formula entered by the operation unit, performing calculation on the basis of the calculation formula information, displaying a result of the calculation on the display unit, and transmitting the acquired calculation formula information to the calculation assistance terminal; and
the calculation assistance terminal performs the processes of determining whether the calculation being performed by the calculation terminal is to be assisted on the basis of the calculation formula information transmitted from the calculation terminal, and in the case of determining that the calculation is to be assisted, outputting calculation assistance information, which is information related to the assistance of calculation being performed by the calculation terminal.

2. The calculation assistance system according to claim 1, wherein the calculation assistance terminal performs the process of:
determining that the calculation being performed by the calculation terminal is to be assisted, when determining whether the calculation being performed by the calculation terminal is to be assisted, and in the case where it is determined that the calculation assistance terminal is superior to the calculation terminal in terms of functions or performance related to calculation of the calculation formula or display of the calculation result indicated by the calculation formula information received from the calculation terminal.

3. The calculation assistance system according to claim 1, wherein the calculation assistance terminal performs the processes of:
storing the calculation assistance information for each of a plurality of calculation formulas of different types of calculation in the storage unit; and
determining that the calculation being performed by the calculation terminal is to be assisted in the case where the calculation assistance information corresponding to the calculation formula indicated by the calculation formula information received from the calculation terminal is stored in the storage unit.

4. The calculation assistance system according to claim 3, wherein the calculation assistance terminal performs the process of:
determining that the calculation being performed by the calculation terminal is to be assisted in the case where the calculation assistance information corresponding to the calculation formula indicated by the calculation formula information received from the calculation terminal is stored in the storage unit, and in the case where it is determined that the calculation assistance terminal is superior to the calculation terminal in terms of functions or performance related to the calculation of the calculation formula or the display of calculation result provided by the calculation assistance information.

5. The calculation assistance system according to claim 2, wherein:
the calculation terminal performs the process of transmitting identification information for identifying the type of the calculation terminal to the calculation assistance terminal in a state where a communication connection is established with the calculation assistance terminal;
the calculation assistance terminal stores functional performance information indicating functions or performance related to calculation of various calculation formulas or display of calculation results, in such a way as to correspond to each of the plurality of the identification information; and
the calculation assistance terminal performs the process of determining, based on the functional performance information stored in such a way as to correspond to the identification information received from the calculation terminal, whether the calculation assistance terminal is superior to the calculation terminal in terms of functions or performance related to calculation of the calculation formula or display of the calculation results indicated by the calculation formula information received from the calculation terminal.

6. The calculation assistance system according to claim 1, wherein:
the calculation terminal performs the processes of sequentially acquiring the calculation formula information, which is information on the calculation formula entered by the operation unit, and sequentially transmitting the acquired calculation formula information to the calculation assistance terminal; and
the calculation assistance terminal performs the processes of:
sequentially determining, based on the calculation formula information sequentially transmitted from the calculation terminal, whether each of the plurality of calculations being performed by the calculation terminal is to be assisted; and
outputting the calculation assistance information corresponding to calculation determined to be assisted.

7. The calculation assistance system according to claim 1, wherein the calculation terminal performs the process of transmitting the calculation formula information corresponding to the entered calculation formula to the calculation assistance terminal in response to the detection of the calculation formula entered via the operation unit, without detecting that the user has performed an operation of individually specifying the calculation formula to be assisted in calculation.

8. The calculation assistance system according to claim 1, wherein the calculation assistance terminal performs the process of display the calculation result in a different form on the display unit of the calculation assistance terminal as calculation assistance information in the case where the calculation assistance terminal determines, based on the calculation formula information, that the calculation is to be assisted by displaying the result of the calculation being performed by the calculation terminal in a form different from the calculation result displayed on the display unit of the calculation terminal.

9. The calculation assistance system according to claim 8, wherein the display of the calculation results in different forms is a display of a graph based on the information on the calculation formula.

10. The calculation assistance system according to claim 8, wherein the display of the calculation results in different forms are a display of calculation results with a greater amount of information than of the calculation terminal.

11. The calculation assistance system according to claim 1, wherein the calculation assistance terminal performs the processes of:
displaying the calculation form, which has a function of outputting a result of a specific calculation based on data entered in an input field, on the display unit of the calculation assistance terminal, where input and output fields are laid out in the case of determining that the calculation is to be assisted by displaying a calculation form for performing a calculation corresponding to the calculation formula based on the information of the calculation formula; and
entering numerical data contained in the information on the calculation formula into the input field and displaying the results of the specific calculation based on the numerical data in the output field.

12. The calculation assistance system according to claim 11, wherein the calculation assistance terminal performs the processes of:
storing a plurality of the calculation forms acquired from the server in advance into the storage unit of the calculation assistance terminal;
acquiring the calculation form corresponding to the information on the calculation formula from the storage unit of acquiring the calculation form corresponding to the information on the calculation formula from the server, in response to receiving the information on the calculation formula from the calculation terminal; and
displaying the acquired calculation form on the display unit.

13. The calculation assistance system according to claim 11, wherein the calculation assistance terminal performs the processes of transmitting the calculation result displayed in the output field of the calculation form to the calculation terminal and displaying the calculation result on the display unit of the calculation terminal.

14. The calculation assistance system according to claim 9, wherein the calculation assistance terminal performs the process of determining whether the calculation being performed by the calculation terminal is to be assisted by determining whether the graph corresponding to the information on the calculation formula is able to be displayed based on the graph formula, which is a formula able to be displayed as a graph stored in the storage unit of the calculation assistance terminal.

15. The calculation assistance system according to claim 10, wherein the calculation assistance terminal performs the process of determining whether the calculation being performed by the calculation terminal is to be assisted by determining whether calculation with a greater amount of information than the calculation terminal is possible based on the functional performance information, which includes calculation accuracy of the calculation terminal stored in the storage unit of the calculation assistance terminal.

16. The calculation assistance system according to claim 12, wherein the calculation assistance terminal performs the process of acquiring the calculation form for performing calculation by using the calculation formula corresponding to the calculation formula indicated by the information on the calculation formula among the plurality of calculation forms stored in the storage unit or acquiring the calculation form for performing calculation by causing the server to search for the calculation form by using the calculation formula corresponding to the calculation formula indicated by the information on the calculation formula among the plurality of calculation forms stored in the server.

17. The calculation assistance terminal used in the calculation assistance system according to claim 1.

18. The calculation terminal used in the calculation assistance system according to claim 1.

19. A calculation assistance method performed by a calculation assistance system including a calculation terminal and a calculation assistance terminal, wherein:
with the calculation terminal in a state where a communication connection is established with the calculation assistance terminal,
the calculation terminal acquires calculation formula information, which is information on a calculation formula entered by an operation unit of the calculation terminal, performs calculation on the basis of the calculation formula information, displays a result of the calculation on a display unit of the calculation terminal:
the calculation terminal transmits the acquired calculation formula information to the calculation assistance terminal;
the calculation assistance terminal determines whether the calculation being performed by the calculation terminal is to be assisted on the basis of the calculation formula information sequentially transmitted from the calculation terminal; and
in the case of determining that the calculation is to be assisted, the calculation assistance terminal outputs calculation assistance information, which is information related to the assistance of calculation being performed by the calculation terminal.

20. A storage medium containing a program executed by a calculation assistance system including a calculation terminal and a calculation assistance terminal, the program used for:
causing the calculation terminal in a state where a communication connection is established with the calculation assistance terminal, to acquire calculation formula information, which is information on a calculation formula entered by an operation unit of the calculation terminal, to perform calculation on the basis of the calculation formula information, to display a result of the calculation on a display unit of the calculation terminal;
causing the calculation terminal to transmit the acquired calculation formula information to the calculation assistance terminal;
causing the calculation assistance terminal to determine whether the calculation being performed by the calculation terminal is to be assisted on the basis of the calculation formula information sequentially transmitted from the calculation terminal; and
in the case of determining that the calculation is to be assisted, causing the calculation assistance terminal to output calculation assistance information, which is information related to the assistance of calculation being performed by the calculation terminal.
